(19) United States
(12) Patent Application Publication
(10) Pub. No.: US 2022/0416291 A1
(43) Pub. Date: Dec. 29, 2022

(54) Lithium Ion Battery and Electric Car with the Same

(71) Applicant: Gree Altairnano New Energy Inc., Zhuhai (CN)

(72) Inventors: Shiyong JIANG, Zhuhai (CN); Shiying ZHAN, Zhuhai (CN); Delei XU, Zhuhai (CN); Haijun LI, Zhuhai (CN); Ahong CHENG, Zhuhai (CN); Saijun DENG, Zhuhai (CN)

(21) Appl. No.: 17/848,425

(22) Filed: Jun. 24, 2022

(30) Foreign Application Priority Data
Jun. 25, 2021 (CN) 202110714367.X

(51) Int. Cl. H01M 10/0525; H01M 50/271; H01M 50/538

(52) U.S. Cl. CPC H01M 10/0525; H01M 50/271; H01M 50/538; H01M 2220/20

(57) ABSTRACT

A lithium ion battery and an electric vehicle with the same are provided. The lithium ion battery includes a cover plate assembly and a battery cell assembly, the cover plate assembly includes a pole and a polarity connecting piece, the pole is connected with the polarity connecting piece, the battery cell assembly is provided with a battery cell tab assembly, and the pole is connected and conducted with the battery cell tab assembly through the polarity connecting piece. As a hard connection, the polarity connecting piece is directly or indirectly connected with the battery cell tab assembly. The polarity connecting piece is in interference fit with the pole for laser welding, so that the connection reliability is high, the overcurrent capability is strong, and electronic conduction is easy.

### TECHNICAL FIELD

The disclosure relates to the technical field of battery design, in particular to a lithium ion battery and an electric car with the lithium ion battery.

### BACKGROUND

With the development of new energy industry, the demand of the electric automobile industry and an energy storage system for lithium ion batteries continuously increases, and the lithium ion batteries play a leading role in the whole new energy industry. Lithium ion batteries on the market at present include polymer pouch batteries, cylindrical batteries and square batteries. The polymer pouch batteries are high in energy density, good in safety and flexible in appearance dimension design, but are not convenient to assemble into a group due to the influence of the structural appearance, and has certain limitation on module PACK, so that the types and models applied to the power battery market are few. Most cylindrical batteries mainly use steel shells or aluminum shells and are widely applied in the power market, but the energy density of the assembled PACK is low, so that the requirement for endurance mileage in the market cannot be met. Most square batteries on the market at present mainly use aluminum shells, and are diversified in product models, strong in assembly grouping property, high in energy density and long in endurance mileage, thus being widely applied to the new energy power industry.

The square battery on the market at present is generally composed of a cover plate assembly, a shell, a battery cell, other auxiliary connecting pieces and auxiliary supporting pieces. The auxiliary connecting pieces are a link for connecting the battery cell and the cover plate assembly, and a closed conductive path is formed in the battery. The auxiliary supporting pieces play a role in fixing and supporting the battery cell, so that the battery cell is insulated from the shell and is prevented from colliding with the shell. In the prior art, the auxiliary connecting pieces in the battery are mostly of flexible connection structures and are configured to connect a battery cell tab and polarity terminal components (positive and negative poles) of the cover plate assembly. Flexible connection is good in heat dissipation capacity, but is weak in current bearing capacity, which is not conducive to improving the rate performance of the battery. Meanwhile, flexible connection is low in welding reliability, therefore, ultrasonic welding and laser welding need to be combined in the welding process in order to enhance the welding strength, but the operation procedure is complex, the working time is long, the production efficiency is low, and consequently, mass production of the battery is affected. At present, the auxiliary supporting pieces in the battery have the problems of poor fixing and limiting performance, low cooperation degree, tedious operation procedure and the like, which is not beneficial to fixing the battery cell and not suitable for mass production of the battery.

### SUMMARY

The disclosure mainly aims to provide a lithium ion battery and an electric car with the lithium ion battery, so as to solve the problem that the current bearing capacity of a battery in the prior art is weak.

In order to achieve the above object, according to an aspect of the disclosure, there is provided a lithium ion battery. The lithium ion battery includes a cover plate assembly and a battery cell assembly, the cover plate assembly includes a pole and a polarity connecting piece, the pole is connected with the polarity connecting piece, the battery cell assembly is provided with at least one battery cell tab assembly, and the pole is connected and conducted with the at least one battery cell tab assembly through the polarity connecting piece.

Furthermore, the lithium ion battery further includes a shell and a supporting part, the battery cell assembly and the polarity connecting piece are disposed in the shell, the supporting part is disposed in the shell and configured to support the battery cell assembly, and the cover plate assembly is disposed at the opening of the shell and connected with the supporting part.

Furthermore, the polarity connecting piece includes a polarity plate body, a first through hole is formed in the polarity plate body, a first protrusion and a first folded edge are disposed on the side, facing the battery cell assembly, of the polarity plate body, a first groove is formed in the edge of the first folded edge, the first protrusion is connected with the supporting part, part of the pole penetrates through the cover plate assembly and extends into the shell to be in interference fit with the polarity plate body through the first through hole, and the groove wall of the first groove is connected with the battery cell tab assembly.

Furthermore, the battery cell assembly includes a battery cell, and the battery cell tab assembly is disposed on the surface of the battery cell. The battery cell tab assembly includes two polarity lugs, a connecting plate and a base plate, two polarity lugs are available and oppositely disposed to form a limiting space, part of the connecting plate is located in the limiting space, an end of the connecting plate extends into the first groove and is connected with the side wall of the first groove, and the base plate is connected with outer surfaces of the two polarity lugs.

Furthermore, the number of the poles is two, the number of the polarity connecting pieces is two, the two battery cell tab assemblies and the two polarity connecting pieces are disposed in a one-to-one correspondence mode, the two polarity connecting pieces and the two poles are disposed in a one-to-one correspondence mode, one of the two battery cell tab assemblies is positive, and the other one is negative.

Furthermore, the cover plate assembly includes a cover plate and an insulating support, at least one second through hole is formed in the cover plate, the poles are located on one side of the outer surface of the cover plate, part of the pole penetrates through the second through hole to be connected with the polarity connecting piece, the insulating support is connected with the cover plate and provided with third through holes corresponding to the second through holes one by one, and an end part of the insulating support is clamped with the supporting part.

Furthermore, the cover plate and the insulating support are provided with fourth through holes, each fourth through hole is provided with an explosion-proof valve and a protective sticker, and the protective sticker is disposed on a side where an outer surface of the explosion-proof valve is located.

Furthermore, the cover plate and the insulating support are provided with fifth through holes, each fifth through hole is provided with a sealing plug and a sealing sticker, and the sealing sticker is disposed on a side where an outer surface of the sealing plug is located.

Furthermore, the cover plate assembly further includes a protective sleeve, the protective sleeve is disposed on the pole in a sleeving mode and located on a side where an outer surface of the cover plate is located, and a sealing ring is disposed between the protective sleeve and the cover plate.

Furthermore, the supporting part includes two fixing frames and two protection plates, the two fixing frames are oppositely disposed and connected in a first direction, the two protection plates are oppositely disposed in a second direction and located on two sides of the fixing frames respectively, the two fixing frames and the two protection plates define an installation space, the battery cell assembly is located in the installation space and provided with two battery cell tab assemblies, and the two battery cell tab assemblies are disposed facing a side where the protection plates are located.

Furthermore, one of the two fixing frames is provided with a locking column, the other fixing frame of the two fixing frames of the two fixing frames is provided with a connecting hole matched with the locking column, or, a first end of each fixing frame is provided with a locking column, and a second end of each fixing frame is provided with a connecting hole.

Furthermore, each fixing frame includes a plate body structure, a first U-shaped plate is disposed on a side, facing the protection plate, of a first end of the plate body structure, a second U-shaped plate is disposed on a side, facing the protection plate, of a second end of the plate body structure, an opening side of the first U-shaped plate and an opening side of the second U-shaped plate are oppositely disposed, and at least one second protrusion is disposed on the outer surface of at least one of the first U-shaped plate and the second U-shaped plate and abuts against a connecting plate of the battery cell tab assembly.

Furthermore, at least one first limiting groove is formed in an end part of the first end of the plate body structure, and a first protrusion of the polarity connecting piece extends into the first limiting groove.

Furthermore, at least one of the first U-shaped plate and the second U-shaped plate is of a hollow structure.

Furthermore, second limiting grooves are formed in outer surfaces of two oppositely arranged side plates of the second U-shaped plate, and part of the protection plates extend into the second limiting grooves.

Furthermore, each protection plate includes a protection plate body, an inner surface of a first end of the protection plate body is of an arc-shaped chamfer structure, a second folded edge is disposed at a second end of the protection plate body, a length direction of the second folded edge is disposed in a width direction of the protection plate body, a third protrusion is disposed on a surface of a side, facing the fixing frame, of the second folded edge, and the third protrusion and a corresponding second limiting groove in the second limiting grooves are disposed in a matched mode.

Furthermore, the protection plate is of a hollow structure, a first limiting column and a second limiting column are disposed on a surface of a side, facing the fixing frame, of the protection plate, the first limiting column and the second limiting column are oppositely disposed, and the first limiting column and the second limiting column abut against the fixing frame.

Furthermore, at least one of the sealing ring and the insulating support is made of PFA material.

According to an aspect of the disclosure, there is provided an electric car, which includes the lithium ion battery, and the lithium ion battery is the abovementioned lithium ion battery.

According to the technical solution, the poles and the polarity connecting pieces are disposed, and the poles are connected and conducted with the battery cell tab assemblies through the polarity connecting pieces. By means of the arrangement, hard connection between the poles and the battery cell tab assemblies is realized, the current bearing capacity of the lithium ion battery can be effectively improved, meanwhile, the heat dissipation capacity of the battery structure is optimized, and the connection reliability of the lithium ion battery is improved.

### BRIEF DESCRIPTION OF THE DRAWINGS

The drawings, which form a part hereof, serve to provide a further understanding of the disclosure, and illustrative embodiments of the disclosure and descriptions thereof serve to explain the disclosure and are not to be construed as unduly limiting the disclosure. In the drawings:

FIG. 1 illustrates an explosive structural schematic diagram of a lithium ion battery according to a first embodiment of the disclosure.

FIG. 2 illustrates an explosive structural schematic diagram of a lithium ion battery according to a second embodiment of the disclosure.

FIG. 3 illustrates a structural schematic diagram of a lithium ion battery according to an embodiment of the disclosure.

FIG. 4 illustrates a structural schematic diagram of a cover plate assembly according to an embodiment of the disclosure.

FIG. 5 illustrates a structural schematic diagram of a protection plate according to a first embodiment of the disclosure.

FIG. 6 illustrates a structural schematic diagram of a protection plate according to a second embodiment of the disclosure.

FIG. 7 illustrates an explosive structural schematic diagram of a cover plate assembly according to a first embodiment of the disclosure.

FIG. 8 illustrates an explosive structural schematic diagram of a cover plate assembly according to a second embodiment of the disclosure.

FIG. 9 illustrates a structural schematic diagram of a fixing frame according to a first embodiment of the disclosure.

FIG. 10 illustrates a structural schematic diagram of a fixing frame according to a second embodiment of the disclosure.

FIG. 11 illustrates an explosive structural schematic diagram of a battery cell assembly according to an embodiment of the disclosure.

FIG. 12 illustrates an explosive structural schematic diagram of a lithium ion battery according to a third embodiment of the disclosure.

Therein, the above-mentioned drawings include the following reference numerals:
1. Cover plate assembly; 2. Battery cell assembly; 3. Shell; 10. Pole; 11. Protective sleeve; 12. Sealing ring;
13. Protective sticker; 14. Explosion-proof valve; 15. Sealing sticker; 16. Sealing plug; 17. Cover plate; 18. Insulating support; 19. Polarity connecting piece;
21. Protection plate; 22. Base plate; 23. Connecting plate; 24. Battery cell; 25, Fixing frame;
170. Second through hole; 182. Third through hole; 180. Fourth through hole; 183. Fifth through hole; 190. First through hole; 191. First groove; 192. First protrusion; 193. First folded edge;
200. Battery cell tab assembly; 201. Polarity lug;
210. Protection plate body; 211. First limiting column; 212. Second limiting column; 214. Second folded edge; 215, third protrusion;
151. Locking column; 252. Connecting hole; 254. First limiting groove; 256. Plate body structure; 257. First U-shaped plate; 258. Second U-shaped plate; 259. Second protrusion; 2581. Second limiting groove.

### DETAILED DESCRIPTION OF THE EMBODIMENTS

It is to be noted that the embodiments and features in the embodiments of the disclosure may be combined with each other without conflict. The disclosure will now be described in detail with reference to the accompanying drawings and the embodiments.

It is to be noted that terms used herein are for the purpose of describing specific implementation modes only and are not intended to be limiting of exemplary implementation modes according to the disclosure. As used herein, the singular forms are intended to include the plural forms as well, unless the context clearly indicates otherwise, and in addition, it should be understood that the terms “includes” and/or “comprises,” when used in this specification, specify the presence of features, steps, operations, devices, components, and/or combinations thereof.

It is to be noted that the terms “first,” “second,” and the like in the specification, the claims and the drawings of the disclosure are used for distinguishing between similar objects and not necessarily for describing a particular sequence or sequential order. It is to be understood that terms so used may be interchanged where appropriate so that the implementation modes of the disclosure described herein can be implemented in other sequences than those illustrated or described herein. In addition, the terms “comprise” and “have” and any variations thereof, are intended to cover a non-exclusive inclusion, e.g., a process, method, system, product, or device that comprises a series of steps or units is not necessarily limited to those steps or units expressly listed, rather, other steps or units not expressly listed or inherent to such process, method, product, or device may be included.

Spatially relative terms, such as “over”, “above”, “on the upper surface”, “upper” and the like, may be used herein for ease of description to describe spatial positional relationship between one device or feature and another device or feature as illustrated in the figures. It should be understood, the spatially relative terms are intended to encompass different orientations in use or operation in addition to the orientation of the device depicted in the figures. For example, if a device in the figures is inverted, devices described as “above” or “over” other devices or formations would then be positioned “below” or “under” the other devices or formations. Thus, the explanatory term “above” can encompass both orientations of “above” and “under.” The device may also be positioned in other different ways (rotated 90 degrees or at other orientations) and the spatially relative descriptions used herein are interpreted accordingly.

The exemplary implementation modes of the disclosure will now be described more fully with reference to the accompanying drawings. However, these explanatory implementation modes may, however, be implemented in many different forms and should not be construed as limited to only the implementation modes set forth herein. It is to be understood that these implementation modes are provided so that this disclosure will be thorough and complete, and will fully convey the concept of these exemplary implementation modes to those of ordinary skill in the art, in the drawings, the thicknesses of layers and regions may be exaggerated for the sake of clarity, like reference numerals are used to denote like devices, and thus descriptions thereof will be omitted.

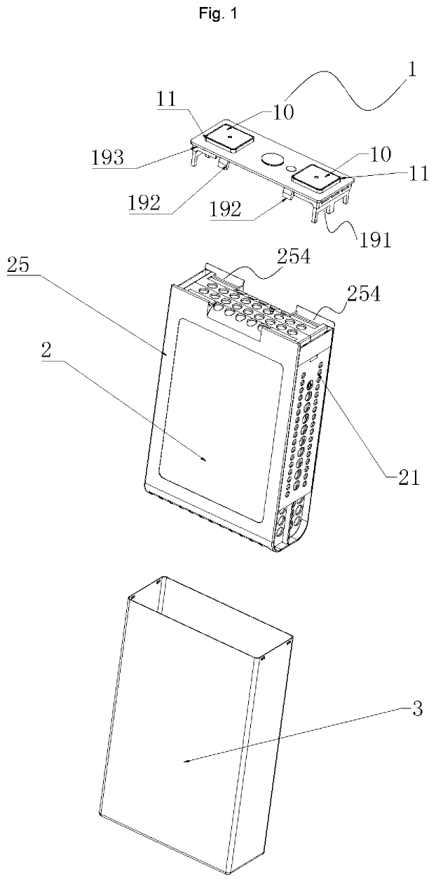

With reference to FIGS. 1-12, a lithium ion battery is provided in accordance with a specific embodiment of the disclosure.

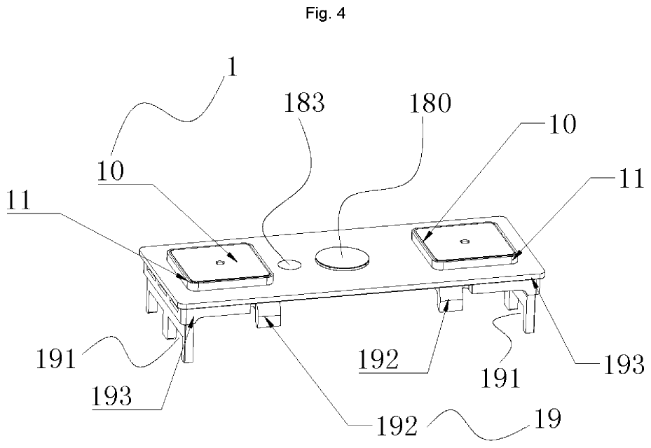

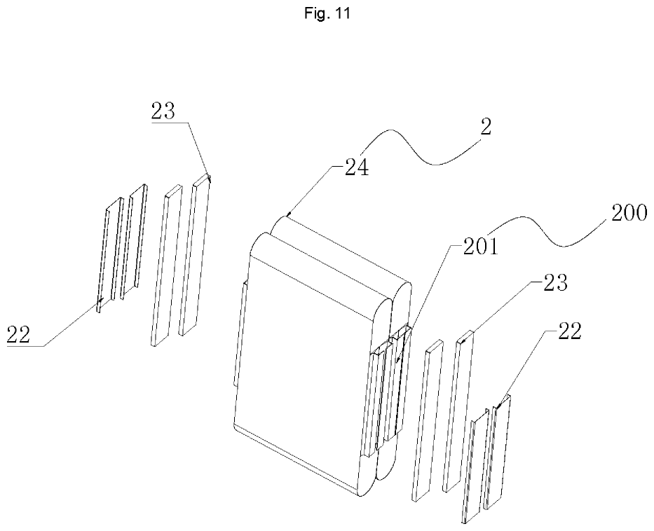

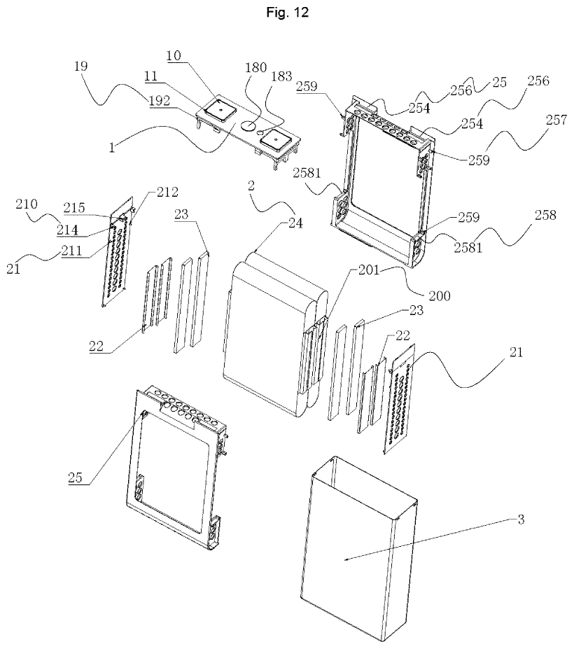

As shown in FIG. 12, the lithium ion battery includes a cover plate assembly 1 and a battery cell assembly 2. As shown in FIG. 4, the cover plate assembly 1 includes a pole 10 and a polarity connecting piece 19, and the pole 10 is connected with the polarity connecting piece 19. As shown in FIG. 11, the battery cell assembly 2 is provided with at least one battery cell tab assembly 200, and the pole 10 is connected and conducted with the at least one battery cell tab assembly 200 through the polarity connecting piece 19. The polarity connecting piece 19 is in interference fit with the pole 10 for laser welding, so that the connection reliability is high, the overcurrent capability is strong, and electronic conduction is easy. Generally, the polarity connecting piece 19 is made of a conductive metal material, in some embodiments, the polarity connecting piece 19 is made of aluminum or copper. The pole 10 and the polarity connecting piece 19 are disposed, and the pole 10 is connected and conducted with the battery cell tab assembly 200 through the polarity connecting piece 19. By means of the arrangement, hard connection between the pole 10 and the battery cell tab assembly 200 is realized, the current bearing capacity of the lithium ion battery can be effectively improved, meanwhile, the heat dissipation capacity of the battery structure is optimized, and the connection reliability of the lithium ion battery is improved.

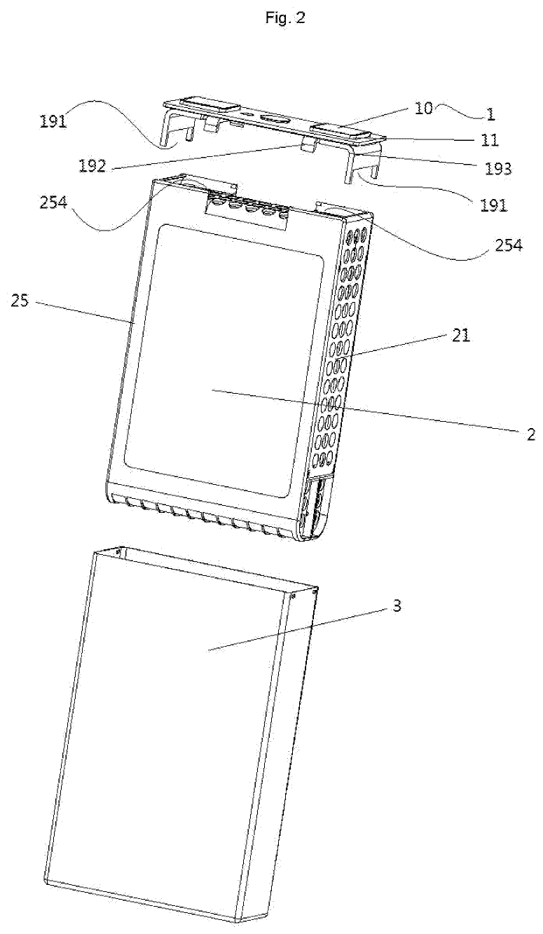

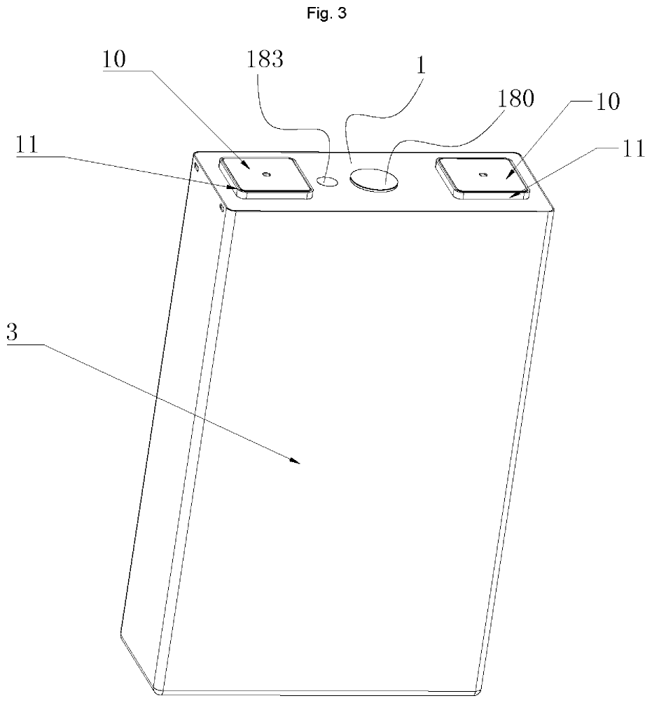

With reference to FIGS. 2 and 3, the lithium ion battery further includes a shell 3 and a supporting part, the battery cell assembly 2 and the polarity connecting piece 19 are disposed in the shell 3, the supporting part is disposed in the shell 3 and configured to support the battery cell assembly 2, and the cover plate assembly 1 is disposed at the opening of the shell 3 and connected with the supporting part. The supporting part is configured for fixing and supporting the battery cell assembly 2, limiting the battery cell assembly and meanwhile preventing a battery cell from being collided. The shell 3 is configured to protect the battery cell assembly 2 for preventing the battery cell assembly 2 from being extruded by the outside, and preventing the battery cell assembly 2 from being corroded by water, oil and the like to cause potential safety hazards.

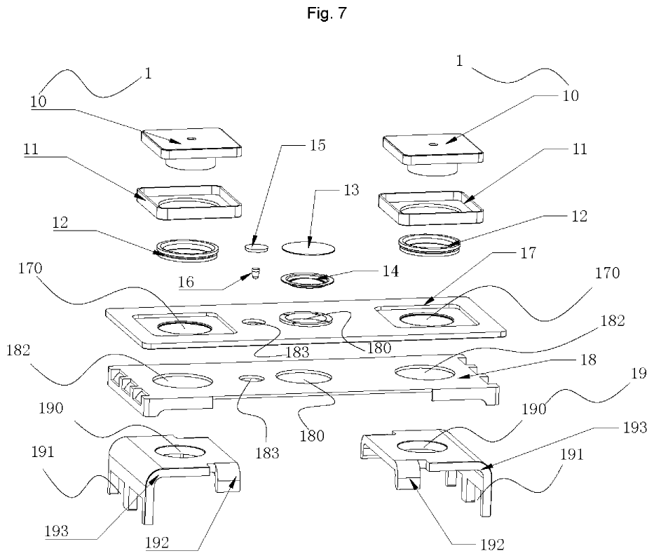

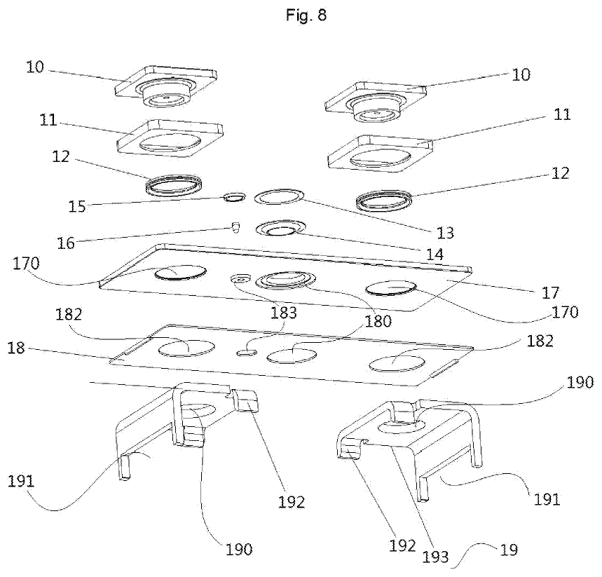

Specifically, with reference to FIGS. 7 and 8, the polarity connecting piece 19 includes a polarity plate body, a first through hole 190 is formed in the polarity plate body, a first protrusion 192 and a first folded edge 193 are disposed on the side, facing the battery cell assembly 2, of the polarity plate body, a first groove 191 is formed in the edge of the first folded edge 193, the first protrusion 192 is connected with the supporting part, part of the pole 10 penetrates through the cover plate assembly 1 and extends into the shell 3 to be in interference fit with the polarity plate body through the first through hole 190, and the groove wall of the first groove 191 is connected with the battery cell tab assembly 200. The number of the first groove 191 may be two (as shown in FIG. 7) or one (as shown in FIG. 8), the groove wall of the first groove 191 is connected with the battery cell tab assembly 200, and normal charging and discharging operation of the battery can be guaranteed.

As shown in FIG. 11, the battery cell assembly 2 includes a battery cell 24, the battery cell tab assembly 200 is disposed on the surface of the battery cell 24, the battery cell tab assembly 200 includes two polarity lugs 201, a connecting plate 23 and a base plate 22, the two polarity lugs 201 are oppositely disposed to form a limiting space, part of the connecting plate 23 is located in the limiting space, an end of the connecting plate 23 extends into the first groove 191 and is connected with the side wall of the first groove 191, and the base plate 22 is connected with outer surfaces of the polarity lugs 201. In a specific embodiment of the battery cell shown in FIG. 11, the number of the battery cells 24 is two, and the two single battery cells 24 are disposed in parallel. The parallel arrangement of the battery cells can increase the capacity of the battery, reduce internal resistance, prolong power supply time and improve the performance of the battery. The two polarity lugs 201 form a limiting space together for fixing the connecting plate 23, so that the connecting plate 23 does not deviate in position. The base plate 22 covers the surfaces of the polarity lugs 201 to play a protection role, so that splashing of welding slag can be effectively prevented in the laser welding process, and the welding reliability can be improved. One end of the connecting plate 23 and the first groove 191 can be tightly connected through laser welding. The connecting plate is a metal aluminum plate or copper plate with the thickness of 1-10 mm and is connected with a tab of the battery cell; and the base plate is a thin plate with the thickness of 10-40 um, in some embodiments, the connecting plate 23 is made of aluminum foil or copper foil.

Furthermore, the number of the battery cell tab assemblies 200 is two, the number of the poles 10 is two, the number of the polarity connecting pieces 19 is two, the two battery cell tab assemblies 200 and the two polarity connecting pieces 19 are disposed in a one-to-one correspondence mode, the two polarity connecting pieces 19 and the two poles 10 are disposed in a one-to-one correspondence mode, one of the two battery cell tab assemblies 200 is positive, and the other one is negative. Each of the numbers of the poles 10, the polarity connecting pieces 19 and the battery cell tab assemblies 200 is two, and the two poles 10, the two polarity connecting pieces 19 and the two battery cell tab assemblies 200 are disposed in a one-to-one correspondence mode. One of the battery cell tab assemblies 200 is positive, and the other one is negative, so that normal charging and discharging operation of the battery is guaranteed.

In some embodiments, as shown in FIGS. 7 and 8, the cover plate assembly 1 includes a cover plate 17 and an insulating support 18, at least one second through hole 170 is formed in the cover plate 17, the poles 10 are located on one side of the outer surface of the cover plate 17, part of the pole 10 penetrates through the second through hole 170 to be connected with the polarity connecting piece 19, the insulating support 18 is connected with the cover plate 17 and provided with third through holes 182 corresponding to the second through holes 170 one by one, and an end part of the insulating support 18 is clamped with the supporting part. The corresponding arrangement of the second through hole 170 and the third through hole 182 enables a part of the pole to smoothly pass through the second through hole 170 and the third through hole 182. The cover plate 17 is used as a structural supporting piece, and the insulating support 18 has the functions of insulation, support and sealing.

Furthermore, the cover plate 17 and the insulating support 18 are provided with fourth through holes 180, each fourth through hole 180 is provided with an explosion-proof valve 14 and a protective sticker 13, and the protective sticker 13 is disposed on a side where an outer surface of the explosion-proof valve 14 is located. The explosion-proof valve 14 and the protective sticker 13 are arranged, so that the phenomenon that the battery explodes under the conditions of overhigh temperature, internal gas expansion, pressure increase and the like can be prevented, and an air pressure safety protection effect is achieved.

The cover plate 17 and the insulating support 18 are provided with fifth through holes 183, each fifth through hole 183 is provided with a sealing plug 16 and a sealing sticker 15, and the sealing sticker 15 is disposed on a side where an outer surface of the sealing plug 16 is located. In some embodiments, in the embodiment of FIGS. 7 and 8, the sealing plug 16 and the insulating support 18 are integrally formed through a nano injection molding process, so that the bonding strength is high, and the sealing performance is good. The sealing plug 16 and the sealing sticker 15 are configured for sealing a liquid injection hole, so that liquid leakage of the battery can be prevented.

The cover plate assembly 1 further includes a protective sleeve 11, the protective sleeve 11 is disposed on the pole 10 in a sleeving mode and located on a side where an outer surface of the cover plate 17 is located, and a sealing ring 12 is disposed between the protective sleeve 11 and the cover plate 17. The protective sleeve 11 is disposed on the pole 10 in a sleeving mode, so that the pole can be prevented being impacted and rubbed by the outside, and the sealing ring 12 is disposed between the protective sleeve 11 and the cover plate 17 to play the roles of isolation, limiting, insulation and supporting.

With reference to FIGS. 1, 2 and 12, the supporting part includes two fixing frames 25 and two protection plates 21, the two fixing frames 25 are oppositely disposed and connected in a first direction, the two protection plates 21 are oppositely disposed in a second direction and located on two sides of the fixing frames 25 respectively, the two fixing frames 25 and the two protection plates 21 define an installation space, the battery cell assembly 2 is located in the installation space and provided with two battery cell tab assemblies 200, and the two battery cell tab assemblies 200 are disposed facing the side where the protection plates 21 are located. The installation space formed by the fixing frames 25 and the protection plates 21 envelopes the whole battery cell assembly 2, so that the movement of the battery cell assembly 2 is limited. In the embodiment, the supporting part is made of PPS insulating material, which is good in dielectric property, resistant to high temperature, resistant to electrolyte corrosion and good in flame retardance, and has certain strength. As shown in FIG. 2, the lithium battery is a square lithium ion battery, the first direction can be the thickness direction of the square lithium ion battery, and the second direction can be the width direction of the square lithium ion battery.

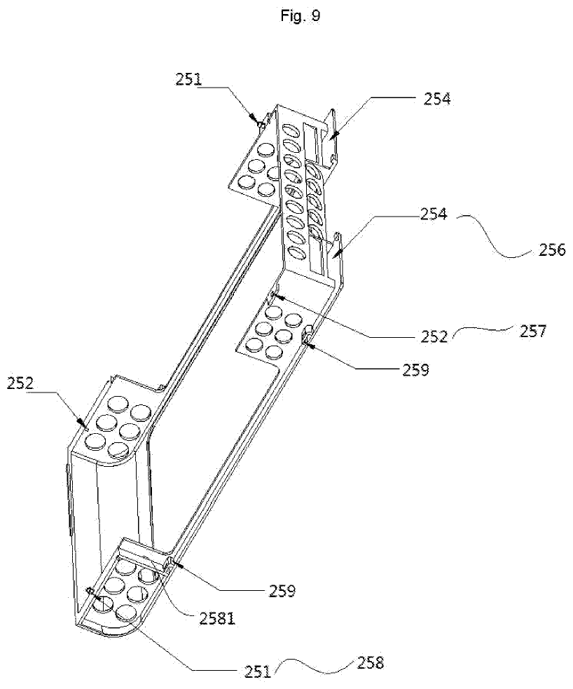

One of the two fixing frames 25 is provided with a locking column 251, the other fixing frame 25 of the two fixing frames 25 is provided with a connecting hole 252 matched with the locking column 251, a first end of each fixing frame 25 is provided with a locking column 251, and a second end of each fixing frame 25 is provided with a connecting hole 252. In some embodiments, as shown in FIG. 9, two pairs of locking columns 251 and connecting holes 252 are formed in upper part and lower part of the fixing frame 25, and the locking columns 251 and connecting holes 252 form a locking structure together, so that battery cell can be fixed and locked during assembly.

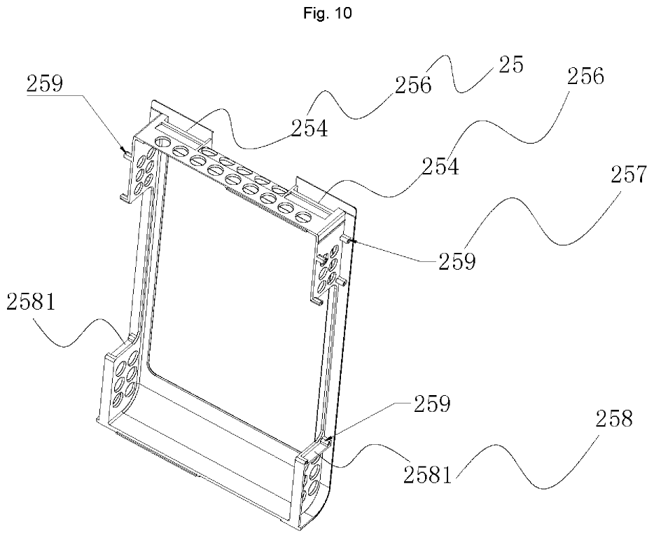

Specifically, as shown by FIGS. 9 and 10, each fixing frame 25 includes a plate body structure 256, a first U-shaped plate 257 is disposed on a side, facing the protection plate 21, of a first end of the plate body structure 256, a second U-shaped plate 258 is disposed on the side, facing the protection plate 21, of a second end of the plate body structure 256, an opening side of the first U-shaped plate 257 and an opening side of the second U-shaped plate 258 are oppositely arranged, and at least one second protrusion 259 is disposed on the outer surface of at least one of the first U-shaped plate 257 and the second U-shaped plate 258 and abuts against a connecting plate 23 of the battery cell tab assembly 200. The second protrusion 259 is used as a limiting structure for limiting and fixing the connecting plate 23.

At least one first limiting groove 254 is formed in an end portion of the first end of the plate body structure 256, and a first protrusion 192 of the polarity connecting piece 19 extends into the first limiting groove 254. In the embodiment shown in FIG. 9, the first limiting groove 254 is of an arc-shaped structure. When the battery is assembled, the first protrusion 192 extends into the first limiting groove 254 and is in contact with the bottom of the first limiting groove 254 for limiting and fixing the polarity connecting piece 19.

In some embodiments, at least one of the first U-shaped plate 257 and the second U-shaped plate 258 is of a hollow structure. Due to the hollow structure, the weight of the battery can be reduced, and the energy density of the battery can be improved.

Furthermore, second limiting grooves 2581 are formed in the outer surfaces of two oppositely disposed side plates of the second U-shaped plate 258, and part of the protection plates 21 extend into the second limiting grooves 2581. Through the arrangement of the second limiting grooves 2581, the protection plate can be matched with the fixing frame to limit and fix the battery cell assembly.

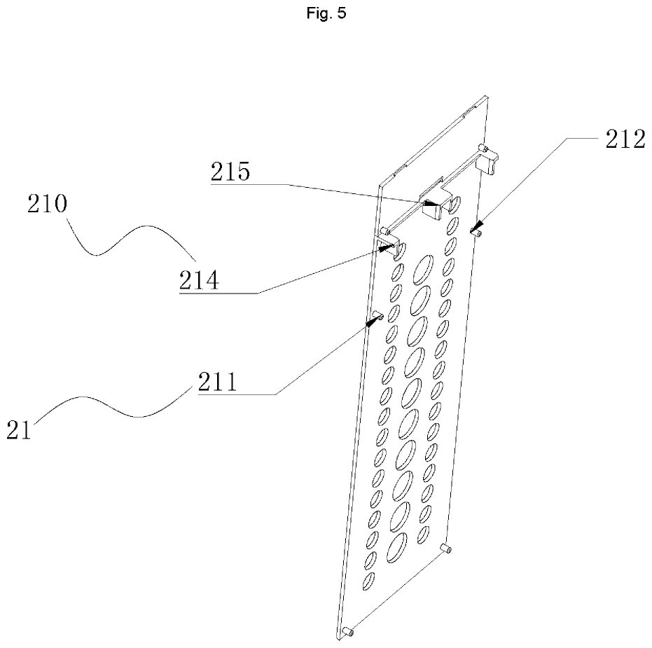

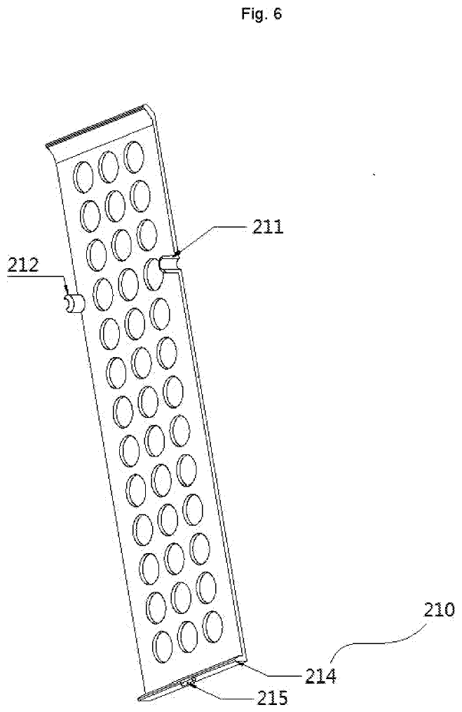

As shown in FIGS. 5 and 6, each protection plate 21 includes a protection plate body 210, the inner surface of the first end of the protection plate body 210 is of an arc-shaped chamfer structure (as shown in FIG. 6), a second folded edge 214 is disposed at a second end of the protection plate body 210, a length direction of the second folded edge 214 is disposed in a width direction of the protection plate body 210, a third protrusion 215 is disposed on a surface of a side, facing the fixing frame 25, of the second folded edge 214, and the third protrusion 215 and a corresponding second limiting groove 2581 in the second limiting grooves are disposed in a matched mode. In the embodiment of the protection plate shown in FIG. 6, the inner surface of the first end of the protection plate body 210 is provided with an arc-shaped chamfer structure, which can be matched with a protruding structure located on the edge of the insulating support 18 in the cover plate assembly 1 shown in FIG. 8 for clamping and fixing, so that the cover plate assembly 1 is limited left and right, and the protection plate 21 is limited to move up and down. The second folded edge 214 is in fixed contact with the surface of the fixing frame 25, so that the third protrusion 215 disposed on the second folded edge is fixed in the second limiting groove 2581 of the fixing frame 25, the battery cell assembly is limited, and the protection plate 21 and the fixing frame 25 are matched, clamped and fixed.

In some embodiments, the protection plate 21 is of a hollow structure, a first limiting column 211 and a second limiting column 212 are disposed on a surface of a side, facing the fixing frame 25, of the protection plate 21, the first limiting column 211 and the second limiting column 212 are oppositely disposed, and the first limiting column 211 and the second limiting column 212 abut against the fixing frame 25. As shown in FIGS. 5 and 6, the first limiting column 211 and the second limiting column 212 are located at the left end and the right end of the protection plate 21 respectively and fixedly limited with the inner surface of the fixing frame 25.

The sealing ring 12 and the insulating support 18 are made of insulating materials and have an insulating effect. In the embodiment, at least one of the sealing ring 12 and the insulating support 18 is made of a PFA material, and an insulating material such as PP, PPS, PFA and PET can be selected according to actual conditions in practical application.

The lithium ion battery in the embodiment can also be applied to the technical field of vehicle equipment, namely, according to another embodiment of the disclosure, there is provided an electric car, which includes the lithium ion battery, and the lithium ion battery is the abovementioned lithium ion battery.

In the above embodiment, the lithium ion battery includes a cover plate assembly, a battery cell assembly, a supporting part and a shell. For the cover plate assembly, a hard connection structure is introduced for connecting the battery cell tab assembly; the supporting part includes a fixing frame and a protection plate, through match and fixing with the cover plate assembly, the battery cell assembly is limited, fixed and supported to prevent collision, and meanwhile, infiltration and permeation of electrolyte are facilitated; the battery cell assembly is composed of a battery cell, a connecting plate and a base plate, the internal space of the battery is increased, the effective space utilization rate is improved, and the heat dissipation capacity of the battery is effectively improved. By improving the structures of the cover plate assembly, the battery cell assembly and the supporting part, the heat dissipation capacity and the overcurrent capacity of structural parts of the battery are enhanced, the welding reliability is improved, the rate performance of the battery is improved, the production efficiency of the battery is improved, and the battery is suitable for mass production.

In an embodiment of the disclosure, the lithium ion battery is a lithium titanate square battery and includes a cover plate assembly 1, a shell 3, a battery cell assembly 2 and a supporting part. The cover plate assembly 1 and the shell 3 are welded through laser to form a closed containing cavity, and the battery cell assembly 2 is located in the containing cavity. The battery cell assembly 2 includes two single battery cells 24 and a battery cell tab assembly 200, and the two single battery cells 24 are connected in parallel. The battery cell tab assembly includes a connecting plate 23, a base plate 22 and a polarity lug 201, the connecting plate 23 is connected with a polarity connecting piece 19 in the cover plate assembly 1 in a laser welding mode, and the supporting part is configured to fix and support a battery cell 24 and limit the battery cell 24 and meanwhile can prevent the battery cell 24 from being collided.

In the embodiment, the cover plate assembly 1 is composed of a polarity terminal component, a sealing ring 12, an insulating support 18, an explosion-proof valve 14, a protective sticker 13, a sealing plug 16 and a sealing sticker 15. The polarity terminal component includes positive and negative poles 10, pole protective sleeves 11 and positive and negative polarity connecting pieces 19, and the polarity connecting pieces 19 are hard connecting pieces and are directly or indirectly connected with the polarity lugs 201. The polarity connecting pieces 19 are in interference fit with the positive and negative poles 10 for laser welding, so that the connection reliability is high, the overcurrent capability is strong, and electronic conduction is easy, and conductive metal aluminum is adopted as the material. Two sides of the insulating support 18 are provided with edge protrusion structures, the polarity connecting piece 19 is provided with a first groove 191 and a first protrusion 192, and the edge protrusion structures, the first groove 191 and the first protrusion 192 have fixing and positioning functions. When the cover plate assembly 1 is assembled, the sealing plug 12 and the insulating support 18 are integrally formed through a nano injection molding process, so that the bonding strength is high, the sealing performance is good, and the sealing ring 12 and the insulating support 18 are made of PFA material.

The battery cell tab assembly 200 includes a polarity lug 201, a connecting plate 23 and a base plate 22, and the connecting plate 23 and the base plate 22 together form a hard connection. The connecting plate 23 is a metal aluminum plate with the thickness of 0.35 mm and is connected with the polarity lug 201; and the base plate 22 is an aluminum foil with the thickness of 20 um, so that splashing of welding slag during laser welding can be prevented, and the reliability of laser welding can be improved. When the battery cell assembly is installed, the polarity lugs 201 of same polarity of the battery cell are equally divided into two parts by equipment or manpower and bent by 90 degrees, so that the polarity lugs are in contact with surface of connecting plate 23, then the internal space of the battery is increased, the utilization rate of effective space is increased, invalid space is avoided, meanwhile, the heat dissipation capacity of battery can be improved, and performance of the battery is improved. When the base plate 22 covers the upper surface of the polarity lug 201, the connecting plate 23, the polarity lug 201 and the base plate 22 are compacted and fastened through tool equipment. Laser welding is carried out, so that the connecting plate 23, the polarity lug 201 and the base plate 22 are tightly connected. The connecting plate 23 is tightly connected with the first groove 191 of the polarity connecting piece 19 in the cover plate assembly 1 through laser welding.

The supporting part is composed of a group of fixing frames 25 and a pair of left and right protection plates 21. The fixing frames 25 and the protection plates 21 envelope the battery cell assembly 2. The fixing frame 25 is provided with a locking structure and a limiting structure. Each locking structure is composed of a locking column 251 and corresponding connecting hole 252, the upper and lower pairs of locking structures are configured for fixing and locking, when the battery is assembled, the battery cell assembly 2 is located in the middle, the battery cell assembly 2 is fixedly locked and completely wrapped by a group of fixing frames 25, and the upper and lower pairs of locking columns 251 and the connecting holes 252 are configured for locking and fixing. The limiting structure is a second protrusion 259 and is configured for limiting the connecting plate 23. The lower end face of the fixing frame 25 is provided with a plurality of stripe-shaped reinforcing rib structures for enhancing the strength. The upper end face of the fixing frame 25 is provided with a first limiting groove 254 arranged as an arc-shaped groove. When battery is assembled, the second protrusion 259 of the polarity connecting piece 19 in the cover plate assembly 1 is in contact with the bottom of first limiting groove 254 of the fixing frame 25 for limiting and fixing the polarity connecting piece 19, and the upper end face is matched with the cover plate assembly 1 for playing a role in fixing and supporting insulating support 18 in the cover plate assembly 1.

The left side and the right side of the protection plate 21 are provided with a first limiting column 211 and a second limiting column 212, the upper end is of an arc-shaped chamfer shape, the lower end face is provided with a second folded edge 214 and a third protrusion 215, and the surface of its main body is of a hollow structure, so that the weight can be reduced, and the energy density of the battery can be improved. The first limiting column 211 and the second limiting column 212 on the left side and the right side of the protection plate 21 are fixedly limited with the inner surface of the fixing frame 25, the arc-shaped chamfer shape of the upper end part of the protection plate 21 can be clamped and fixed with the edge protrusion structure of the insulating support 18 in the cover plate assembly 1, and the second folded edge 214 on the lower end face of the protection plate 21 is fixedly contacted with the surface of the fixing frame 25, so that the third protrusion 215 on the lower end surface of the protection plate 21 is fixed in the second limiting groove 2581 of the fixing frame 25. The supporting part is made of PPS insulating material, which is good in dielectric property, resistant to high temperature, resistant to electrolyte corrosion and good in flame retardance, and has certain strength.

Furthermore, the polarity connecting piece 19 of the cover plate assembly is limited and clamped with a first limiting groove 254 in the upper end portion of the fixing frame 25 in the battery cell assembly 2, and the edge protrusion structure of the insulating support 18 in the cover plate assembly 1 is in contact, fixing and clamping with an arc-shaped chamfer structure in the upper end part of the protection plate 21 in the battery cell assembly 2, and the protection plate 21 is limited to move up and down.

In the embodiment, according to the technical solution, the structure design of polarity hard connection is introduced, the structure of the cover plate assembly is optimized, the structure of the battery supporting part is improved, so that the bad phenomena of low welding reliability, low production efficiency, poor battery rate performance and the like in the prior art are avoided, the heat dissipation capacity and the overcurrent capacity of structural parts are improved, the welding reliability is improved, and improvement of the rate capability is facilitated. Meanwhile, the square battery is high in production efficiency and suitable for mass production.

In addition to the foregoing, it should be appreciated that reference throughout this specification to “one embodiment,” “another embodiment,” “an embodiment,” or the like, means that a particular feature, structure, or characteristic described in connection with the embodiment is included in at least one embodiment described generally in this application. The appearances of the same recitations in various places in the specification are not necessarily referring to the same embodiment. Furthermore, when a particular feature, structure, or characteristic is described in connection with any embodiment, it is submitted that it is within the scope of the disclosure to effect such feature, structure, or characteristic in connection with other embodiments.

In the embodiments of the disclosure, the descriptions of the respective embodiments have respective emphasis, and for parts that are not described in detail in a certain embodiment, reference may be made to the related descriptions of other embodiments.

The foregoing is merely some embodiments of the disclosure and is not intended to limit the disclosure, and various modifications and variations of the disclosure may be available for those skilled in the art. Any modification, equivalent replacement, improvement and the like made within the spirit and principle of the disclosure shall fall within the scope of protection of the disclosure.

What is claimed is:

1. A lithium ion battery, comprising:
a cover plate assembly, comprising a pole and a polarity connecting piece, and the pole is connected with the polarity connecting piece;
a battery cell assembly, provided with at least one battery cell tab assembly, and the pole is connected and conducted with the at least one battery cell tab assembly through the polarity connecting piece.

2. The lithium ion battery as claimed in claim 1, further comprising:
a shell and the battery cell assembly and the polarity connecting piece are disposed in the shell;
a supporting part, disposed in the shell and configured to support the battery cell assembly, and the cover plate assembly is disposed at the opening of the shell and connected with the supporting part.

3. The lithium ion battery as claimed in claim 2, wherein the polarity connecting piece comprises:
a polarity plate body, a first through hole is formed in the polarity plate body, a first protrusion and a first folded edge are disposed on the side, facing the battery cell assembly, of the polarity plate body, a first groove is formed in the edge of the first folded edge, the first protrusion is connected with the supporting part, part of the pole penetrates through the cover plate assembly and extends into the shell to be in interference fit with the polarity plate body through the first through hole, and the groove wall of the first groove is connected with the battery cell tab assembly.

4. The lithium ion battery as claimed in claim 3, wherein the battery cell assembly comprises a battery cell, the battery cell tab assembly is disposed on the surface of the battery cell, and the battery cell tab assembly comprises:
two polarity lugs, wherein the two polarity lugs are oppositely disposed to form a limiting space;
a connecting plate, part of the connecting plate is located in the limiting space, and an end of the connecting plate extends into the first groove and is connected with the side wall of the first groove;
a base plate, wherein the base plate is connected with outer surfaces of the two polarity lugs.

5. The lithium ion battery as claimed in claim 1, wherein there are two battery cell tab assemblies and two poles, the number of the polarity connecting pieces is two, the two battery cell tab assemblies and the two polarity connecting pieces are disposed in a one-to-one correspondence mode, the two polarity connecting pieces and the two poles are disposed in a one-to-one correspondence mode, wherein one of the two battery cell tab assemblies is positive, and the other one is negative.

6. The lithium ion battery as claimed in claim 2, wherein the cover plate assembly comprises:
a cover plate, at least one second through hole is formed in the cover plate, the poles are located on one side of the outer surface of the cover plate, and part of the pole penetrates through the second through hole to be connected with the polarity connecting piece; and
an insulating support, the insulating support is connected with the cover plate and provided with third through holes corresponding to the second through holes one by one, and an end part of the insulating support is clamped with the supporting part.

7. The lithium ion battery as claimed in claim 6, wherein the cover plate and the insulating support are provided with fourth through holes, each fourth through hole is provided with an explosion-proof valve and a protective sticker, and the protective sticker is disposed on a side where an outer surface of the explosion-proof valve is located.

8. The lithium ion battery as claimed in claim 6, wherein the cover plate and the insulating support are provided with fifth through holes, each fifth through hole is provided with a sealing plug and a sealing sticker, and the sealing sticker is disposed on a side where an outer surface of the sealing plug is located.

9. The lithium ion battery as claimed in claim 6, wherein the cover plate assembly further comprises:
a protective sleeve, the protective sleeve is disposed on the pole in a sleeving mode, the protective sleeve is located on a side where an outer surface of the cover plate is located, and a sealing ring is disposed between the protective sleeve and the cover plate.

10. The lithium ion battery as claimed in claim 2, wherein the supporting part comprises:
two fixing frames, the two fixing frames are oppositely disposed and connected in a first direction;
two protection plates, the two protection plates are oppositely arranged in a second direction, the two protection plates are located on two sides of the two fixing frames respectively, the two fixing frames and the two protection plates define an installation space, the battery cell assembly is located in the installation space, the battery cell assembly is provided with two battery cell tab assemblies, and the two battery cell tab assemblies are disposed facing a side where the protection plates are located.

11. The lithium ion battery as claimed in claim 10, wherein one of the two fixing frames is provided with a locking column, the other fixing frame of the two fixing frames is provided with a connecting hole matched with the locking column, or, a first end of each fixing frame is provided with a locking column, and a second end of the each fixing frame is provided with a connecting hole.

12. The lithium ion battery as claimed in claim 11, wherein each fixing frame comprises:
a plate body structure, a first U-shaped plate is disposed on a side, facing the protection plate, of a first end of the plate body structure, a second U-shaped plate is disposed on a side, facing the protection plate, of a second end of the plate body structure, an opening side of the first U-shaped plate and an opening side of the second U-shaped plate are oppositely disposed, and at least one second protrusion is disposed on the outer surface of at least one of the first U-shaped plate and the second U-shaped plate and abuts against a connecting plate of the battery cell tab assembly.

13. The lithium ion battery as claimed in claim 12, wherein at least one first limiting groove is formed in an end part of the first end of the plate body structure, and a first protrusion of the polarity connecting piece extends into the first limiting groove.

14. The lithium ion battery as claimed in claim 12, wherein at least one of the first U-shaped plate and the second U-shaped plate is of a hollow structure.

15. The lithium ion battery as claimed in claim 12, wherein second limiting grooves are formed in outer surfaces of two oppositely disposed side plates of the second U-shaped plate, and part of the protection plates extend into the second limiting grooves.

16. The lithium ion battery as claimed in claim 15, wherein each protection plate comprises:
a protection plate body, an inner surface of a first end of the protection plate body is of an arc-shaped chamfer structure, a second folded edge is disposed at a second end of the protection plate body, a length direction of the second folded edge is disposed in a width direction of the protection plate body, a third protrusion is disposed on a surface of a side, facing the fixing frame, of the second folded edge, and the third protrusion and a corresponding second limiting groove in the second limiting grooves are disposed in a matched mode.

17. The lithium ion battery as claimed in claim 10, wherein the protection plate is of a hollow structure, a first limiting column and a second limiting column are disposed on a surface of a side, facing the fixing frame, of the protection plate, the first limiting column and the second limiting column are oppositely disposed, and the first limiting column and the second limiting column abut against the fixing frame.

18. The lithium ion battery as claimed in claim 9, wherein at least one of the sealing ring and the insulating support is made of PFA material.

19. An electric car, comprising the lithium ion battery, wherein the lithium ion battery comprises:
a cover plate assembly, comprising a pole and a polarity connecting piece, and the pole is connected with the polarity connecting piece;
a battery cell assembly, provided with at least one battery cell tab assembly, and the pole is connected and conducted with the at least one battery cell tab assembly through the polarity connecting piece.

20. The electric car as claimed in claim 19, wherein the lithium ion battery comprises:
a shell, and the battery cell assembly and the polarity connecting piece are disposed in the shell;
a supporting part, disposed in the shell and configured to support the battery cell assembly, and the cover plate assembly is disposed at the opening of the shell and connected with the supporting part.
